(19) United States
(12) Patent Application Publication
(10) Pub. No.: US 2004/0156327 A1
(43) Pub. Date: Aug. 12, 2004

(54) System employing wireless means for governing operation of an apparatus and methods of use therefor

(76) Inventors: Norbert E. Yankielun, Lebanon, NH (US); Robert E. Sattin, Wilmington, NC (US)

Correspondence Address: HUMPHREYS ENGINEER CENTER SUPPORT ACTIVITY, ATTN: CEHEC-OC, 7701 TELEGRAPH ROAD, ALEXANDRIA, VA, 22315-3860, US

(21) Appl. No.: 10/778,706

(22) Filed: Feb. 11, 2004

(51) Int. Cl. H04B 7/00

(52) U.S. Cl. 370/310

(57) ABSTRACT

A system employing principles of the present invention governs operation of an apparatus by an operator. An embodiment of the present invention comprises means for receiving at least one signal, portable means affixed to the operator for transmitting the signal, and means for inactivating or interrupting the operation of the apparatus should the operator be beyond a pre-specified distance from the controls of the apparatus. The means for inactivating communicates with both the means for receiving and the apparatus, while the means for transmitting sends the signal to the means for receiving during normal operation of the apparatus, e.g., with the operator physically present. Without the presence of the signal, operation of the apparatus is interrupted. One embodiment provides for an emergency override of the system to permit operation of the apparatus without the presence of the signal. Methods of using embodiments of the present invention are also provided.

### STATEMENT OF GOVERNMENT INTEREST

Under paragraph 1(a) of Executive Order 10096, the conditions under which this invention was made entitle the Government of the United States, as represented by the Secretary of the Army, to the entire right, title and interest therein of any patent granted thereon by the United States. This patent and related ones are available for licensing. Contact Sharon Borland at 703 428-9112 or Phillip Stewart at 601 634-4113.

### BACKGROUND

In some countries, small boat manufacturers are required to install an emergency cut-off switch (“kill” switch or “dead-man” switch) on every motorized small watercraft. A lanyard attached to the operator usually actuates this switch. When pulled, the lanyard actuates the switch, cutting the ignition to the engine. This switch prevents a runaway boat situation by cutting power if the operator leaves his control position, including unexpectedly as would occur in a man overboard situation. A system similar to that mandated for small boats is also useful for insuring safe operation of other powered equipment in the event of operator dysfunction or accident.

Although state and local laws mandate the use of this cut-off switch, most operators do not attach this lanyard to themselves because it limits their movement about the vessel. Further, use of a means to assure operator attention to controls would be beneficial to reduce losses in serious accidents. For example, statistics collected on mandatory reports of boating accidents indicate that the number one reason for serious accidents is operator inattention, while the number two reason, careless or reckless operation, is also related to operator inattention and sub-standard performance. Boating Statistics—2002, United States Coast Guard, COMDTPUB P16754.16, 43 pp, 2003.

### BRIEF DESCRIPTION OF THE DRAWINGS

FIG. 1 is a block diagram of an embodiment of the present invention.

FIG. 2A is a block diagram of a controller and representative sensors, indicators and switches that may be used with the transmitter depicted in FIG. 1.

FIG. 2B depicts a panel that may be used with the transmitter depicted in FIG. 1.

FIG. 3 is a block diagram including an alternate transmitter-receiver pair that may be used in an embodiment of the present invention.

FIG. 4A is a diagram of the node depicted in FIG. 3 indicating some functions permitted by software that may be used in an embodiment of the present invention.

FIG. 4B depicts a panel that may be used on the receiver depicted in FIG. 3.

FIG. 4C depicts a top view of the transmitter of FIG. 3 as employed in an embodiment of the present invention.

FIG. 5 depicts the embodiment of FIG. 3 that adds a remote control.

### DETAILED DESCRIPTION

In general, an embodiment of the present invention promotes active onsite operation of an apparatus by an operator. The apparatus may be a conveyance, a vehicle, a vessel, an aircraft, a recreational device, a robot, a power tool, machinery, control mechanisms, and combinations thereof (all not shown separately).

An embodiment of the present invention comprises means for receiving at least one electromagnetic signal, portable means affixed to the operator for transmitting the signal, and means for interrupting the operation of the apparatus. The means for interrupting communicates with both the means for receiving and the apparatus. The means for transmitting sends a signal to the means for receiving during normal operation of the apparatus. The means for interrupting operation of the apparatus prevents operation of the apparatus under pre-specified conditions. For example, in one embodiment of the present invention, if the operator strays from the controls of the apparatus more than three meters (m) (about ten ft) or so, the signal from the means for transmitting becomes so weak at the means for receiving that the means for interrupting operation is activated, thus preventing, at least temporarily, operation of the apparatus.

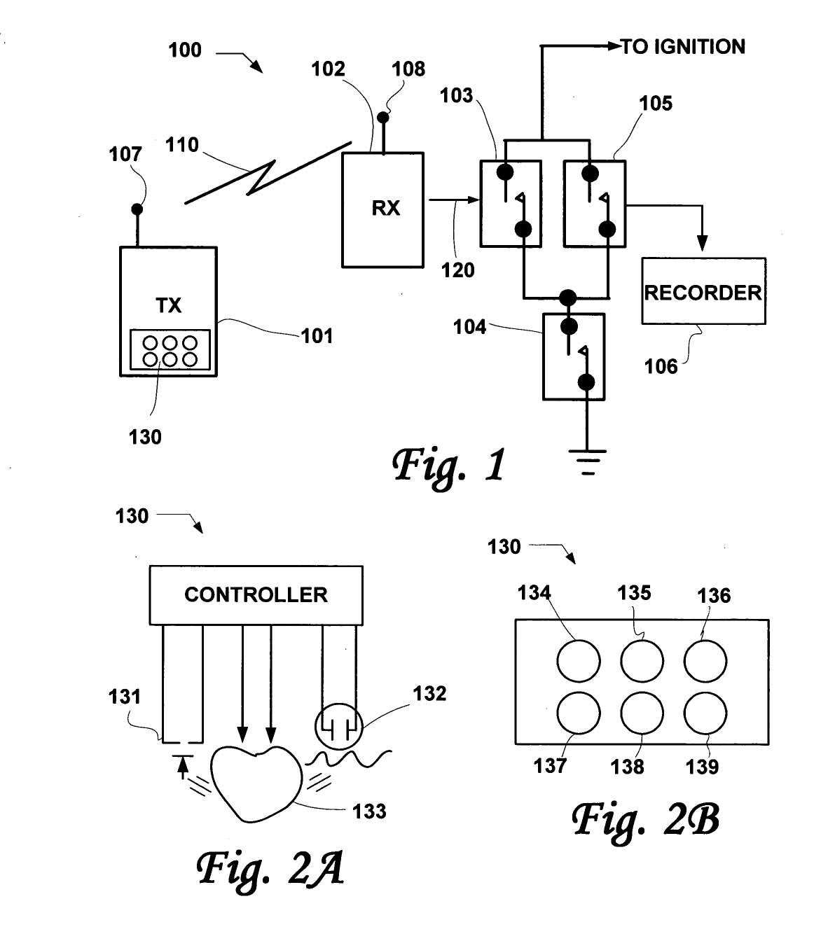

Refer to FIG. 1. One embodiment of the present invention comprises a receiver 102 with antenna 108, a portable transmitter 101 with antenna 107 that may be affixed to the person of an operator, and circuitry (not shown separately) that facilitates communication between the receiver 102 and an enabling function of an apparatus, such as an ignition switch 104. The circuitry includes an enabling/disabling mechanism, such as a relay 103 and enables operation of the apparatus to be interrupted under pre-specified conditions, such as when an operator strays from the vicinity of the controls of the apparatus, falls overboard while operating a watercraft, etc.

The transmitter 101 sends a signal 110 for receipt by the receiver 102 during normal operation of the apparatus by an operator present at the controls of the apparatus and equipped with the transmitter 101. In one embodiment of the present invention, the signal is an electromagnetic signal 110 that may be operated at carrier frequencies that include radio frequencies (RF), optical frequencies, audio frequencies, and combinations thereof. For embodiments of the present invention employing RF frequencies, preferred are VHF and UHF frequencies authorized by the Federal Communications Commission (FCC). In one embodiment of the present invention, it is preferable that the signal 110 be digitally encoded and, most preferably, pulse code modulated. In one embodiment of the present invention, the signal 110 is provided at an average power between about 0.1 mW and 1.0 W, preferably less than about 100 mW, and most preferably between about 10 and 50 mW.

In one embodiment of the present invention, the receiver 102 is powered by a source associated with the apparatus and batteries (not shown separately) power the transmitter 101. In a specific embodiment of the present invention, the receiver 101 is powered directly from an onboard continuous DC power supply (not shown separately), such as the main battery incorporated in the apparatus. In one embodiment of the present invention, the receiver 102 is connected to or communicates wirelessly with deadman circuitry. The deadman circuitry may be located at least partially within the receiver in one embodiment except for an interrupt device such as a relay 103. The interrupt device, such as an electrical relay 103, is placed in series with the ignition switch 104 of the apparatus. In one embodiment of the present invention, the relay 103 is a “normally open” (NO) relay, i.e., when it is not energized by receipt of a signal 120 from the receiver 102 within a pre-specified interval, the relay 103 is open, inhibiting operation of the ignition switch 104.

In one embodiment of the present invention, the transmitter 101 may have a capacity for warning that is visual, audible, physical by contact, such as a vibration, and combinations thereof. The warning may be associated to a low battery condition or other anomaly indicating operation of the transmitter 101 is not within a pre-specified standard. The receiver 102 also may incorporate visual or audible warnings associated with anomalous operation. An embodiment of the present invention may provide for the transmitter 101 to be de-activated if submerged in a fluid for a pre-specified period such as may occur in a man-overboard event.

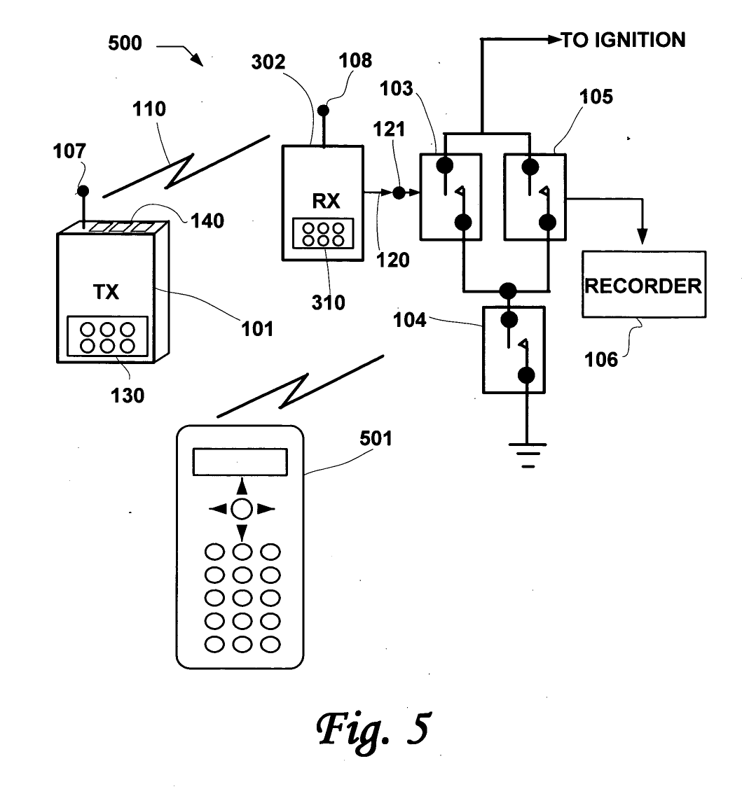

Refer to FIG. 5. Further, in an embodiment of the present invention, operation of the transmitter 101, receiver 102, or both may be by a remote control 501, in one embodiment a remote control 501 requiring coded or keyed access.

In embodiments of the present invention, an override capability, part of which may be implemented as a relay 105, is provided for overriding the function of the present invention in the event of an emergency or equipment malfunction. The override capability may be affixed to controls of the apparatus, communicate with controls of the apparatus, e.g., through the receiver 102 and its associated antenna 108, or both. In embodiments of the present invention, the override capability may include circuits that incorporate a relay 105, a switch, a re-set button, and combinations thereof. In various embodiments of the present invention, the override capability may be accessed at the apparatus, transmitter 101, receiver 102, remote control 501, and combinations thereof.

Embodiments of the present invention may further include a recorder 106 that operates to record communication between a device on the apparatus, such as a relay 105, and the override capability on any or all of the transmitter 101, receiver 102 and the remote control 501.

Embodiments of the present invention may include software that implements algorithms for governing response of the apparatus during operation. In one embodiment of the present invention, the software is incorporated in the receiver 102, although all or parts of the software may be installed in any or all of the devices: receiver 102, transmitter 101, remote control 501, and apparatus.

Also provided in embodiments of the present invention are methods governing operation of an apparatus by an operator. In an embodiment of the present invention a method of use comprises providing means for receiving a signal that is provided at least in proximity to controls of an apparatus; providing and affixing to an operator portable means for transmitting the signal; and providing means for interrupting the operation of the apparatus based on the absence of a signal of sufficient strength at the receiver 102, e.g., received signal strength in a range less than about −20 to −80 dBm. The portable means for transmitting sends the signal to the means for receiving for at least some time during the normal operation of the apparatus. The means for interrupting communicates with both the means for receiving and the apparatus such that the means for interrupting prevents at least temporary operation of the apparatus under pre-specified conditions, such as man overboard or operator leaving the vicinity of the controls of the apparatus.

In one embodiment of the present invention, a continuous carrier signal is employed. The transmitter 101 generates a constant single-frequency signal 110 at an appropriate frequency for receipt by the receiver 102. While this method employs very simple circuitry (not shown separately), there are two considerations that may warrant an alternative solution: battery life and interference with like systems operating nearby. A continuous signal considerably shortens battery life. Further, unless the signal is encoded, other sources could cause the system 100 to malfunction. Thus an alternative embodiment of the present invention employs a brief, periodic, encoded signal 110, such as a pulsed or burst continuous wave (CW) digitally encoded signal, to both extend battery life and eliminate the potential for interference. These signal modulation and encoding techniques are known in the art, existing for radio-operated garage door openers, for example. In addition, custom encoding techniques may be used to meet needs of a specific user.

Suitable for use with an embodiment of the present invention is a technique that uses periodic bursts of a digital signal employing pulse code modulation (PCM). Other digital or analog encoding schemes are also possible. In one embodiment of the present invention, the transmitter 101 periodically sends a burst of unique PCM code at repetition intervals between one second and one minute, and more preferably between about three seconds and 30 seconds, and most preferably between about five and 10 seconds, although other repetition intervals may be selected depending on user requirements. In this embodiment, or any other non-continuous transmission, the deadman circuitry permits continued operation of the apparatus between transmissions of the signal 110 and may provide for a pre-specified number of repetition intervals to be missed before interrupting operation of the apparatus.

In one embodiment of the present invention a signal at any of the repetition intervals stated above may have a duration of approximately 10-50 milliseconds (ms) to conserve battery power. After more than a pre-specified number of repetition intervals of non-receipt of the signal 110 by the receiver 102, the ignition to the apparatus is interrupted. Preferably this occurs after one to five repetition intervals of non-receipt of the signal 110 and most preferably after two repetition intervals of non-receipt of the signal 110 if the repetition interval is not more than ten seconds.

In one embodiment of the present invention, a method governing the operation of an apparatus by an operator comprises providing a receiver 102 affixed at least in proximity to the apparatus; providing a portable transmitter 101 affixed to the operator; and providing circuitry (not shown separately) that permits communication between the receiver 102 and the apparatus. The transmitter 101 sends a signal to the receiver 102 during normal operation of the apparatus. The circuitry interrupts operation of the apparatus under pre-specified conditions. In an alternative method of the present invention, a remote control 501, which in one embodiment may be operated by an access code, is provided for purposes of governing operation of at least one of the transmitter 101, receiver 102, or apparatus.

In one embodiment of the present invention, a method is provided for implementing operation of an apparatus under active direction of an operator. The method comprises affixing at least one portable transmitter 101 to the operator; affixing a receiver 102 onto, or nearby, the apparatus; and activating the transmitter 101 upon initiation of active direction of the apparatus by the operator. The transmitter 101 sends a signal 110 to the receiver 102 during any time that the operator remains able to direct operation of the apparatus, i.e., during normal operation of the apparatus. Without conscious action by the operator, operation of the apparatus is interrupted upon non-receipt of the signal 110 within a pre-specified period.

In one embodiment of the present invention, a method further provides for overriding operation of the transmitter 101, receiver 102 and associated circuitry by a mechanism, such as a remote control 501 that may be accessed by a code. The override capability may also be accomplished by locating a physical switch or button on the receiver 102, transmitter 101, or apparatus. The override mechanism permits the apparatus to be operated in an emergency or upon equipment malfunction.

In one embodiment of the present invention, the method further provides a recorder 106 that records each time the override mechanism is used, providing at least the date and time of each use of the override mechanism. Upon use of the override mechanism, the recorder may also be employed to record selected operational parameters of the apparatus, e.g., engine speed, coolant temperature, oil pressure, etc., thus serving much the same purpose as a flight recorder in an aircraft.

### EXAMPLE 1

Refer to FIG. 1. In one embodiment of the present invention suitable for use with powered machinery directed by an operator, a wireless radio transmitter 101—receiver 102 pair, is used to disrupt power from the ignition switch 104 of an apparatus upon occurrence of pre-specified conditions. Disruption may be by way of a relay 103 and, as an example of one pre-specified condition, may occur when an operator locates beyond some pre-specified distance from the controls of that system.

In an embodiment of the present invention, deadman circuitry incorporating interrupting means, such as a “kill” switch or relay 103, is implemented in a configuration 100 suited to the operation of a powered watercraft (not shown separately). A receiver 102 is interfaced 120 to a relay 103 in series between the ignition system of the watercraft's engine and an ignition switch 104 that is typically activated by manual use of a key (not shown separately). The interface 120 may be by wireless communication from the antenna 108 of the receiver 102 or hardwired. For either means, the functions carried out thereby are designated by a node 121, with some of the functions enumerated as at FIG., 4A. Hard connection of the interface 120 may be by electrically conductive wires, optical fibers, hydraulics, and combinations of these.

Refer to FIG. 4A. The node 121 may facilitate a number of commands or actions to be transferred to the apparatus from the system 300 to include a delay, an encoded key for accessing the smart receiver 302, the apparatus, or both, a query as to system status and present logic being used, etc. Any or all of these functions as represented by the node 121 may be initiated over a communication path 120 that may be any of the hard connection to the smart receiver 302 and apparatus as designated above, via wireless communication through the antenna 108 of the smart receiver 301, or both.

The receiver 102 is specified to detect an electromagnetic signal 110 only above a pre-specified minimum level, e.g., about −40 dBm for an RF signal. In one embodiment of the present invention, the signal 110 is a unique, encoded, electromagnetic signal 110 that may operate at RF, optical or acoustical frequencies. The receiver 102 may be further specified to receive only specifically encoded ones of such signals.

The transmitter 101 is a portable battery-powered system located on the person of an operator of the watercraft. The transmitter 101 emits a low-powered signal 110 of limited range with respect to the rated sensitivity of the receiver 102, typically less than one watt (W) average power output with a range in respect to the transmitter 101—receiver 102 pair limited by the rated sensitivity of the receiver 102 to about 3 m (10 ft). The transmitter 101 may have the physical dimensions and appearance of a pager (not shown separately) or small cellular phone (not shown separately).

Refer to FIGS. 2A and 2B. The transmitter may have provisions 130 for control by the operator, to include buttons, switches, indicators, and combinations thereof that: power up/down 134 the transmitter 101 itself, self-test 135, override 136 operation of the transmitter to an emergency transmitter relay 131, enable monitoring 137 by one or more biometric monitors 133, query/display battery condition 138, and query/status 139 an emergency water immersion switch 133.

In one embodiment of the present invention, the average power output of the transmitter 101 is less than 100 mW and preferably between 10 and 50 mW. In one embodiment of the present invention, the transmitter 101 may be affixed to the body of the operator, carried on a belt (not shown separately) or carried in a pocket (not shown separately). As long as the receiver 102 recognizes the signal from the transmitter 101, the ignition switch 104 remains engaged with the ignition of the apparatus. If the operator, with the transmitter affixed to his person, steps outside the pre-specified range of the transmitter 101—receiver 102 pair, the receiver 102 no longer recognizes the transmitter signal 110 and the relay 103 is disengaged upon occurrence of pre-specified conditions, such as non-receipt of a proper signal by the receiver 102 during a pre-specified interval. The pre-specified interval is set to meet local standards or specific user requirements and may be between 5 seconds and a minute or more, but typically between 10 and 20 seconds.

### EXAMPLE 2

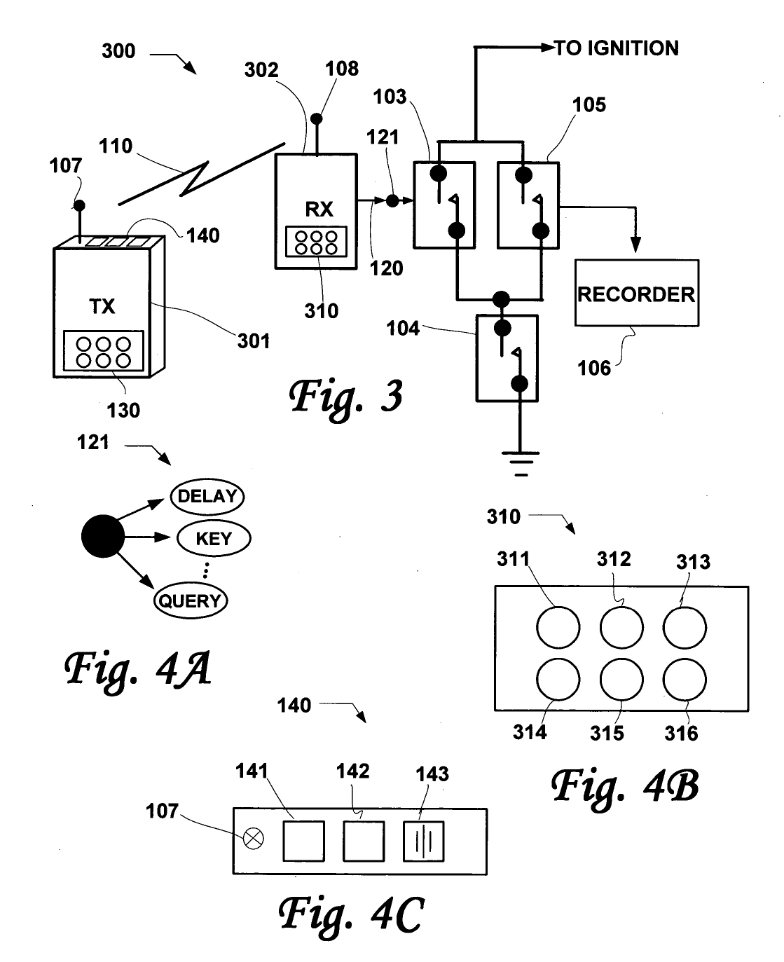

Refer to FIG. 3. A “self-monitoring” or “alerting” transmitter 301 of an embodiment of the present invention shown in the configuration 300 operates at low power, typically less than about 100 mW. An embodiment of the alerting transmitter 301 of the present invention is implemented with one or more rechargeable batteries (not shown separately) and operates within authorized VHF/UHF (or above) RF bands. Further, the signal 110 from the alerting transmitter 301 is frequency and modulation matched to a “smart” receiver 302 based on pre-loaded or programmable logic in the smart receiver 302. Both the alerting transmitter 301 and the smart receiver 302 may be configured selectively to operate with one or more unique signals 110, including signals that are unique to a particular operator.

At the end of normal operation of the apparatus, the alerting transmitter 301 is de-activated and the batteries may be recharged depending on level of charge. Alternatively, standard (non-rechargeable) batteries (not shown separately) may be used and replaced at appropriate intervals.

Refer to FIG. 4C. In one embodiment of the present invention, the alerting transmitter 301 employs indicating means 140 to alert to its status. These may include visual 141, such as a light emitting diode, physical contact 142, such as a vibrator, or audible 143 means, such as a buzzer, and any combination of the above means. These indicating means 140 may display a low battery condition or equipment malfunction as well as proper operation of the transmitter. Visual means (not shown separately) may further provide an indication of remaining battery life or source of malfunction.

Further, the controls 130 of the alerting transmitter 301 may include options similar to those described in Example 1 above. One embodiment of the present invention may include a storage compartment (not shown separately) in the alerting transmitter 301 for extra batteries. An embodiment of the present invention may also include means (not shown separately) for entering codes or selecting specific coded signals, e.g., via a separate device (not shown separately) that is plugged into the alerting transmitter 301 or communicates wirelessly through the transmitter antenna 107.

In one embodiment of the present invention, the smart receiver 302 is programmed to recognize an encoded signal 110 from the alerting transmitter 301. As long as that encoded signal 110 is received at a pre-specified period, the ignition is energized. The digitally encoded signal transmission/reception capability may be similar to that existing in the IC chip set used for automatic garage openers. The same means for entering codes or selecting specific coded signals may be used to “set” the smart receiver 302 through either its antenna 108, a plug-in on the smart receiver 302 itself, or both.

In one embodiment of the present invention, the alerting transmitter 301 is equipped with a manual emergency override switch 136 that an operator activates to send a code to the smart receiver 302 to immediately activate the ignition via relay 105. Of course, the ignition may be inactivated by simply powering the transmitter off using a suitable switch 134 on the alerting transmitter 301.

In one embodiment of the present invention, the alerting transmitter 301 is equipped with a water-sensing cutoff switch 132. Thus, if the operator were to go overboard, the alerting transmitter 301 ceases operation upon or shortly after water immersion.

Refer to FIG. 4B. In one embodiment of the present invention, the smart receiver 302 itself, as opposed to the override switch 105 of the apparatus, includes a manual override 313, allowing the ignition to be activated in response to an emergency condition such as when the primary operator is incapacitated or the alerting transmitter 301 is malfunctioning. The smart receiver 302 may also include buttons or indicators, or both to perform or indicate functions such as: on/off power switch/indicator 311, self-test switch/indicator 312, program receipt indicator 314 that shows receipt and installation of a specific program, a status indicator 315 as relates to signal strength received and imminent interruption of the ignition, and an indication 316 that activity is being recorded on a recorder 106.

In one embodiment of the present invention, a “biometric” interface calibration (or “personalization”) for the one or more biometric sensors 133 may be necessary. Further, the input from the biometric sensors 133, when converted to a suitable format, may be used to uniquely encode the signal 110 form the alerting transmitter 301 by modulating the signal 110 with unique biometrics such as heart rate, body temperature, blood pressure, breathing rate, and combinations thereof. Using this capability, a system 300 may be programmed for use by only a select few operators since the enabling transmission, encoded in both the alerting transmitter 301 and the smart receiver 302, would work only if the authorized operator were providing the modulation via the attached biometric sensor(s) 133. For example, loss or sudden change in the heart rate of the operator may both interrupt the system and alert the operator as to his current ability to continue operation or the need for properly installing the device on his person. Further, the biometric sensor 133, such as a heart rate monitor, may have a calibrated “window” of thresholds for given operators such that too high or too low a heart rate indicates operator trouble or an unauthorized operator.

### EXAMPLE 3

Refer to FIG. 5 adding a remote control 501 to the configuration 300 of FIG. 3. When an embodiment of the present invention interrupts operation of the apparatus it is protecting, the apparatus must be restarted. In this configuration 500, for emergencies, an override relay 105 may be implemented by controls located on the apparatus, on the smart receiver 302 such as shown at 310, on the alerting transmitter 301 such as shown at 130, or on a remote control 501, or combinations of these. An override capability, typically implemented on the apparatus in a relay 105, is wired parallel to the operative element in the deadman circuitry for bypassing the deadman circuitry, typically a relay 103. In one embodiment of the present invention, this bypass, or emergency override, capability is used when the primary operator is incapacitated and another person must operate the system or when equipment associated with an embodiment of the present invention becomes inoperative, e.g., dead batteries. The use of the remote control 501 to perform an override enables activation of the apparatus when the transmitter 301-receiver 302 pair is damaged or inaccessible due to physical impediments such as may be caused by an accident.

This override capability facilitates operator recovery or rescue should the need arise. In one embodiment of the present invention, to insure that this override capability is not used during normal operation of the apparatus, a record of its employment may be maintained on a recorder 106 that is monitored by an inspector or other management personnel. The recorder 106 may be a simple digital system on a chip with a readout that provides a date/time stamp of usage. Further, in one embodiment of the present invention, the recorder 106 may be “ruggedized,” powered by its own energy source (not shown separately), and accessed via a key or code known to a limited number of personnel. Access to the recorder 106 from the override switches may be by a hardwired connection 120 for the smart receiver 302 and apparatus as described above or via the antenna 108 on the smart receiver 302, the antenna 107 on the alerting transmitter 302, the remote control 501, or any combination thereof.

Potential applications of embodiments of the present invention include wireless emergency inactivation switches for exercise equipment, military, industrial and manufacturing equipment and machinery, automobiles to foil car-jacking, braking unattended baby strollers, and for preventing unauthorized use of powered recreational equipment. In the case of keyed ignitions, even if the ignition switch 104 is compromised, without the coded alerting transmitter 301, the protected apparatus will not operate, given that the manual override switch 105 is similarly protected by encoding or a key.

For anti-car jacking applications, an embodiment of the present invention may be equipped with a delay to enable the operator to separate himself from the car thieves by a safe distance. Thus, in one embodiment of the present invention, the system is programmed to operate at a given time delay after car-jacking has occurred, typically 5-10 minutes. This may be programmed to occur only when the unauthorized operator (car-jacker) has brought the vehicle to a complete stop on his own volition, thus avoiding liability concerns over involuntarily stopping the car while moving at high speed.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 CFR § 1.72(b). Any advantages and benefits described may not apply to all embodiments of the invention.

We claim:

1. A system governing operation of controls of an apparatus by an operator, comprising:
at least one receiver;
at least one portable transmitter affixed to at least one said operator, wherein said transmitter sends at least one signal for receipt by said receiver for at least some time during said operation; and
circuitry in operable communication with at least said receiver and said apparatus, wherein said circuitry interrupts operation of said apparatus under at least one pre-specified condition.

2. The system of claim 1 in which said signal employs a carrier frequency in the ranges selected from the group consisting essentially of: radio frequencies (RF), optical frequencies, audio frequencies, and combinations thereof.

3. The system of claim 2 in which said RF frequencies are within VHF and UHF frequency ranges authorized by the Federal Communications Commission (FCC).

4. The system of claim 1 in which said signal is an encoded digital signal.

5. The system of claim 4 in which said encoded signal is pulse code modulated.

6. The system of claim 1 in which said receiver is powered by a source associated with said apparatus.

7. The system of claim 1 in which said signal is provided at an average power between about 0.1 mW and 1.0 W.

8. The system of claim 1 in which said transmitter is powered by batteries.

9. The system of claim 1 in which said transmitter further comprises a capacity for warning selected from the group of warning types consisting of: visual, audible, physical, and combinations thereof.

10. The system of claim 1 in which said in which said warning is associated to a low battery condition.

11. The system of claim 1 in which said transmitter is de-activated via submersion in a fluid for a pre-specified period.

12. The system of claim 1 further comprising at least one override circuit in operable communication with said apparatus.

13. The system of claim 12 in which said override circuit comprises at least one device selected from the group consisting of: a relay, a switch, a re-set button, and combinations thereof.

14. The system of claim 12 further comprising a recorder in operable communication with at least said override circuit.

15. The system of claim 1 in which said apparatus is selected from the group consisting essentially of: a conveyance, a vehicle, a vessel, an aircraft, a recreational device, a robot, a power tool, machinery, control mechanisms, and combinations thereof.

16. The system of claim 1 further comprising at least one remote control, wherein said remote control may communicate with any of said receiver, said transmitter, said circuitry and said apparatus.

17. The system of claim 16 further comprising software implementing at least one algorithm for initiating at least one response of said apparatus during operation.

18. The system of claim 17 in which at least part of said software is incorporated in any of said receiver, said transmitter, said remote control, said apparatus, and combinations thereof.

19. The system of claim 1 in which said pre-specified condition is selected from the group of conditions consisting essentially of: separation of said operator from controls of said apparatus by a pre-specified distance, incapacitation of said operator, unauthorized control of said transmitter, and combinations thereof.

20. The system of claim 1 further comprising at least one biometric sensor in operable communication with said transmitter.

21. The system of claim 20 in which at least one output from said biometric sensor is used to modulate at least one said signal.

22. A system governing operation of an apparatus by an operator, comprising:
means for receiving at least one signal;
portable means affixed to said operator for transmitting said signal, wherein said portable means for transmitting sends said signal to said means for receiving for at least some time during said operation; and
means for interrupting said operation, said means for interrupting in operable communication with said means for receiving and said apparatus, wherein said means for interrupting prevents operation of said apparatus under pre-specified conditions.

23. The system of claim 22 further comprising means for overriding operation of said system.

24. The system of claim 22 further comprising means for remotely controlling said system.

25. The system of claim 22 further comprising biometric sensing means in operable communication with at least said portable means for transmitting.

26. The system of claim 23 further providing at least one means for recording in operable communication with at least said means for overriding, wherein said means for recording captures at least the date and time of each use of said means for overriding.

27. A method governing operation of an apparatus by an operator, comprising:
providing means for receiving at least one signal;
providing and affixing to said operator portable means for transmitting said signal to said means for receiving, wherein said portable means for transmitting sends said signal to said means for receiving for at least some time during said operation; and
providing means for interrupting said operation, said means for interrupting in operable communication with said means for receiving and said apparatus, wherein said means for interrupting prevents operation of said apparatus under pre-specified conditions.

28. The method of claim 27 further providing means for overriding operation of said system.

29. The method of claim 28 further providing means for recording in operable communication with at least said means for overriding, wherein said means for recording records at least the date and time of each use of said override mechanism.

30. The method of claim 28 further providing means for remotely controlling at least some operations of said system.

31. The method of claim 27 further providing means for biometric sensing in operable communication with at least said portable means for transmitting.

32. A method governing operation of an apparatus by an operator, comprising:
providing at least one receiver affixed at least in proximity to said apparatus;
providing at least one portable transmitter affixed to said operator, wherein said transmitter sends at least one signal to said receiver for at least some time during said operation; and
providing circuitry in operable communication with said receiver and said apparatus, wherein said circuitry interrupts operation of said apparatus under pre-specified conditions.

33. The method of claim 32 further providing at least one override mechanism in operable communication with at least one of said transmitter, said receiver, and said circuitry.

34. The method of claim 33 further providing at least one remote control in operable communication with any one of said portable transmitter, said receiver, said circuitry, said override mechanism, and combinations thereof.

35. The method of claim 32 further providing at least one biometric sensor in operable communication with at least said portable transmitter.

36. A method for implementing operation of an apparatus under active direction of an operator, comprising:
providing and affixing at least one portable transmitter to said operator;
providing and affixing at least one receiver at least in proximity to said apparatus;
providing circuitry for interrupting said operation, said circuitry at least enabling operable communication between at least said apparatus and said receiver; and
activating said transmitter upon initiation of said active direction by said operator, wherein said transmitter sends at least one signal for at least a portion of said operation from said transmitter to said receiver while the operator remains able to direct operation of the apparatus, and wherein said operation is interrupted upon non-receipt of said signal within a pre-specified period.

37. The method of claim 36 further providing at least one override mechanism in operable communication with at least one of said transmitter, said receiver, and said circuitry.

38. The method of claim 37 further providing at least one remote control in operable communication with any one of said portable transmitter, said receiver, said circuitry, said override capability, and combinations thereof.

39. The method of claim 36 further providing at least one biometric sensor in operable communication with at least said portable transmitter.

40. The method of claim 37 further providing at least one recorder in operable communication with at least said override mechanism, wherein said recorder records at least the date and time of each use of said override mechanism.
